(19) United States
(12) Patent Application Publication
(10) Pub. No.: US 2015/0153747 A1
(43) Pub. Date: Jun. 4, 2015

(54) TORQUE CONTROL DEVICE

(71) Applicant: Akira Tanabe, Tokyo (JP)

(72) Inventor: Akira Tanabe, Tokyo (JP)

(73) Assignee: MITSUBISHI ELECTRIC CORPORATION, Chiyoda-ku, Tokyo (JP)

(21) Appl. No.: 14/400,182

(22) PCT Filed: Aug. 6, 2012
(86) PCT No.: PCT/JP2012/004966

§ 371 Date: Dec. 5, 2014

(51) Int. Cl. G05D 17/02; G05B 15/02

(52) U.S. Cl. CPC G05D 17/02; G05B 15/02

(57) ABSTRACT

For a torque control device that drives a torque control shaft in synchronism with a main control shaft while applying, through the torque control shaft, a predetermined pushing force to a workpiece driven by the main control shaft, a torque control device is obtained which can prevent a positional deviation from being generated even when the main control shaft is moved. The maximum and minimum values of the mechanical parameter representing the mechanical property of the driver driven by the torque control shaft are stored, and either the maximum or minimum mechanical parameter value stored in a memory means is selected according to the main control shaft's driving state, whereby drive torque necessary for following up the main control shaft's driving can be calculated so as to cause the pushing force to be augmented.

### TECHNICAL FIELD

The present invention relates to a torque control device that controls so as to drive a torque control shaft in synchronism with a main control shaft.

### BACKGROUND ART

The torque control device that controls so as to drive the torque control shaft in synchronism with the main control shaft is used in, for example, an automatic lathe equipped with a material feeder. In the material feeder equipped automatic lathe, provided are a main shaft mounting on which a main shaft rotationally driving a workpiece is mounted, and a material feeder which feeds the workpiece to the main shaft; the main control shaft horizontally moves the main shaft mounting, and the torque control shaft horizontally moves the material feeder to apply a constant load to the workpiece. Positon and velocity control of the main control shaft is performed in a feedback manner by a main control device controlling the main control shaft, with the main control shaft's position data being inputted. Furthermore, the torque control device controlling the torque control shaft controls to drive the torque control shaft in synchronism with the main control shaft, so that the workpiece is pushed to the main shaft at a constant load.

In the torque control device applied to the material feeder equipped automatic lathe, only constant torque control is performed without cooperating with the horizontal movement control of the main shaft mounting. That is, the material feeder is pushed to the workpiece, which just results in synchronously operating the main control device according to load torque. Therefore, when the main shaft mounting is moved, acceleration/deceleration torque required for acceleration/deceleration in accordance with the movement of the main shaft mounting becomes insufficient, whereby the relative position between the main shaft mounting and the material feeder is varied (positional deviation), causing a problem that the workpiece cannot be suitably supported.

For suppressing the positional deviation generated by the main shaft mounting's movement, a method has been proposed in which in the torque control device, torque generated by the torque control shaft is not controlled only using constant preset torque, but is controlled using suitably corrected torque.

For example, a technique has been disclosed in which a detection device such as a linear scale device is provided for detecting the material feeder's relative displacement with respect to the main shaft mounting's movement, to determine torque to be generated according to the detected relative displacement (for example, refer to Patent Document 1).

Furthermore, a technique has been disclosed in which a velocity data input means is provided for inputting velocity data of the main shaft mounting, acceleration data is calculated from the velocity data, and compensation torque in accordance with the acceleration component is added to a torque command(for example, refer to Patent Document 2).

### PRIOR ART DOCUMENT

### Patent Document

Patent Document 1: Japanese Patent Laid-Open Publication No. H08-39301

Patent Document 2: Japanese Patent Laid-Open Publication No. H10-136682

### DISCLOSURE OF INVENTION

### Problem to be Solved by the Invention

However, in the technique disclosed in Patent Document 1, it is necessary to provide a delay detection means by a linear scale device; therefore, there have been problems that the torque control device has a complicated structure and the device itself becomes expensive.

In the technique disclosed in Patent Document 2, in order to calculate acceleration/deceleration torque necessary for synchronizing with the main control shaft, conversion to acceleration/deceleration torque is performed by multiplying acceleration data by an inertia moment. Therefore, in a case where the inertia moment used for the calculation includes an error, a problem has occurred that a positional deviation generated between the main shaft mounting and the material feeder cannot be sufficiently suppressed.

The present invention is made in view of the problems described above, and aims at obtaining a torque control device that has a simpler structure and can suppress, even in a case where the main shaft mounting is moved, a positional deviation to be generated.

### Means for Solving Problem

In order to solve the problems described above, a torque control device according to the present invention in which while a driver driven by a torque control shaft applies a pushing force to a workpiece driven by a main control shaft, the torque control shaft is driven in synchronism with the main control shaft, includes: a mechanical parameter setting means that sets a mechanical parameter representing a mechanical property of the driver on the basis of a driving state of the main control shaft so as to cause the pushing force to be augmented; a follow-up drive torque calculator that calculates follow-up drive torque necessary for the torque control shaft to follow up the driven main control shaft, on the basis of the mechanical parameter set by the mechanical parameter setting means and the driving state of the main control shaft; and a torque control means that calculates a torque command value by adding the follow-up drive torque and preset torque being set separately, and controls the torque control shaft so that the torque control shaft's torque agrees with the torque command value.

### Effect of the Invention

According to the present invention, a torque control device is configured so as to calculate a torque command value according to driving states of the main control shaft; therefore, it is not necessary to additionally provide a delay detection means using a linear scale device, thereby simplifying the structure of the torque control device.

For a positional deviation generated by an error in a mechanical parameter, taking a variation in the mechanical parameter into account, a suitable mechanical parameter can be selected and a torque command value can be calculated so that pushing force is always large, thereby easily preventing the positional deviation from being generated.

### BRIEF DESCRIPTION OF THE DRAWINGS

FIG. 1 is a configuration view in which a torque control device in Embodiment 1 of the present invention is applied to an automatic lathe equipped with a material feeder;

FIG. 2 is a block diagram showing the configuration of an inertia moment setting means in Embodiment 1 of the present invention;

FIG. 3 shows waveform graphs representing a relation between driving states of a main control shaft and drive torque in Embodiment 1 of the present invention;

FIG. 4 is a block diagram showing the configuration of a friction coefficient setting means in Embodiment 1 of the present invention; and

FIG. 5 shows waveform graphs representing a relation between the driving states of the main control shaft and the drive torque in Embodiment 1 of the present invention.

### NUMERAL EXPLANATION

W workpiece
1 main shaft
2 main shaft mounting
3 main shaft feed screw
4 main shaft motor
5 detector
6 main control device
7 auxiliary shaft feed screw
8 material feeder
10 auxiliary shaft motor
11 torque control device
12 controller
20 driving state calculator
21 inertia moment setting means
22 friction coefficient setting means
23 drive torque calculator
24 torque control means
25 inertia moment selection means
26 friction coefficient selection means
26 friction coefficient selection means

### MODE FOR CARRYING OUT THE INVENTION

An embodiment of a torque control device according to the present invention will be explained in detail below, using figures. In addition, it should be noted that the present invention is not limited by this embodiment.

### Embodiment 1

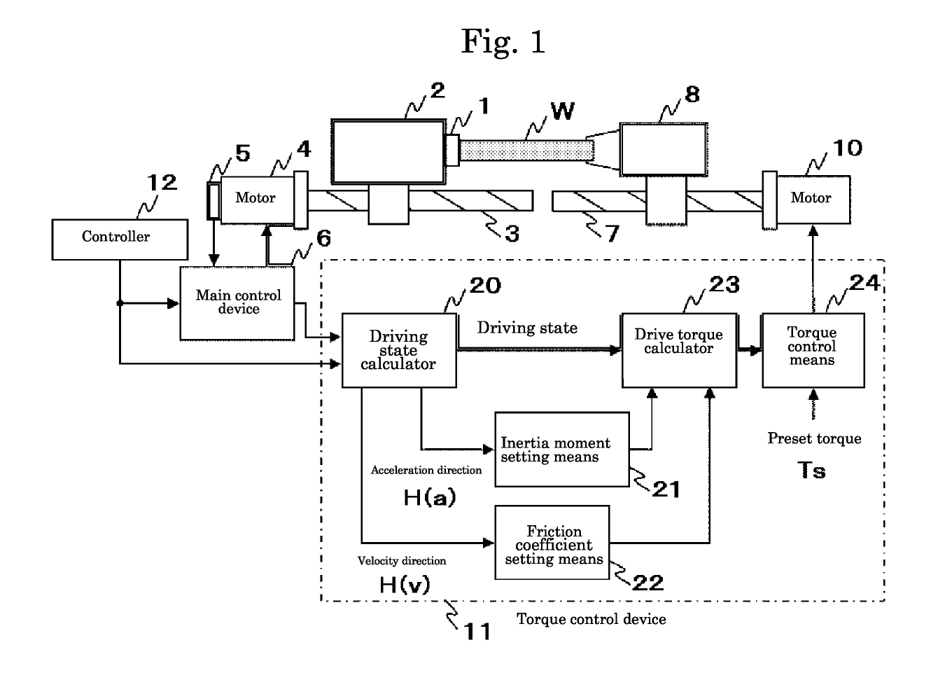

The torque control device according to Embodiment 1 of the present invention will be explained below, using FIG. 1 to FIG. 5.

FIG. 1 is a configuration view in which the torque control device in Embodiment 1 of the present invention is applied to an automatic lathe equipped with a material feeder. A main shaft 1 fixes a workpiece W, and rotationally drives the workpiece W. A main shaft mounting 2 on which the main shaft 1 is mounted is fitted with a main shaft feed screw 3. A main shaft motor 4 (a main control shaft) rotationally drives the main shaft feed screw 3, thereby causing the main shaft mounting 2 to be horizontally moved. A detector 5 attached to the main shaft motor 4 detects the rotation position of the main shaft motor 4; the detected position data of the main control shaft is inputted to a main control device 6 which drives and controls the main shaft motor 4. The main control device 6 performs positon control and velocity control for the main shaft mounting 2 in a feedback manner. A controller 12 outputs a position command signal, i.e. a target value for driving the main control shaft, to the main control device 6. A material feeder 8 is fitted with an auxiliary shaft feed screw 7. An auxiliary shaft motor 10 (a torque control shaft) rotationally drives the auxiliary shaft feed screw 7, which thereby causes the material feeder 8 to be horizontally driven to feed the workpiece W to the main shaft 1 and also apply to the workpiece W, a horizontal load pushing the workpiece W to the main shaft 1 during machining the workpiece. A torque control device 11 performing torque control of the torque control shaft controls to drive the auxiliary shaft motor 10 according to the preset torque, that is, performing torque control of the torque control shaft so that the material feeder 8 applies a constant load to the workpiece W.

In the torque control device 11, the position command signal outputted from the controller 12 and a detection signal from the detector 5 detecting the rotation position of the main control shaft controlled by the main control device 6 are inputted to a driving state calculator 20. The driving state calculator 20 calculates and outputs states of driving in the main control shaft, such as the main control shaft's velocity and acceleration, and their directions (for example, their sign information). Acceleration direction information outputted from the driving state calculator 20 is inputted to an inertia moment setting means 21, and the inertia moment setting means 21 outputs an inertia moment. Velocity direction information outputted from the driving state calculator 20 is inputted to a friction coefficient setting means 22, and the friction coefficient setting means 22 outputs a friction coefficient. The main control shaft's driving states such as the velocity and acceleration outputted from the driving state calculator 20, the inertia moment outputted from the inertia moment setting means 21, and the friction coefficient outputted from the friction coefficient setting means 22 are inputted to a drive torque calculator 23, so that the drive torque calculator calculates and outputs drive torque necessary for following-up the main control shaft's movement. The drive torque outputted from the drive torque calculator 23 necessary for following-up the main control shaft's movement and preset torque Ts having been separately set are inputted to a torque control means 24, so that on the basis of the drive torque, the torque control means calculates a torque command value that is torque in the torque control shaft, and performs, according to the torque command value, torque control for the auxiliary shaft motor 10 being the torque control shaft.

The driving state calculator 20 calculates and outputs the main control shaft's driving states such as the velocity and acceleration and their direction information (the sign information) on the basis of the position command signal for the main control shaft outputted from the controller 12, or on the basis of the detection signal from the detector 5 detecting the rotation position of the main control shaft controlled by the main control device 6.

Here, the velocity direction information and the acceleration direction information are calculated using a sign handling function H(x) as shown below where a value of the velocity or the acceleration is assigned to x, and outputted as the velocity direction information or the acceleration direction information.

in a case of x>0: H(x)=+1

in a case of x=0: H(x)=0

in a case of x<0: H(x)=−1 Equation 1

Based on the acceleration direction information that is numerically expressed by the sign handling function H(x) and outputted from the driving state calculator 20, the inertia moment setting means 21 calculates and outputs an inertia moment which is a mechanical parameter used for calculating the torque control shaft's drive torque.

Based on the velocity direction information that is numerically expressed by the sign handling function H(x) and outputted from the driving state calculator 20, the friction coefficient setting means 22 calculates and outputs a friction coefficient which is a mechanical parameter used for calculating the torque control shaft's drive torque.

Details of the inertia moment setting means 21 and the friction coefficient setting means 22 will be described later.

Based on the driving states such as the main control shaft's velocity and acceleration outputted from the driving state calculator 20 and based on the mechanical parameters such as the inertia moment calculated by the inertia moment setting means 21 and the friction coefficient calculated by the friction coefficient setting means 22, the drive torque calculator 23 calculates and outputs, using an equation below, drive torque necessary for the torque control shaft to follow up the main control shaft's movement. In the equation, Th is the drive torque necessary for the torque control shaft to follow up the movement of the main control shaft; a is the acceleration of the main control shaft; v is the velocity of the main control shaft; J is the inertia moment; c is the friction coefficient; and H is the sign handling function expressed in Equation 1.

Th=a·J+c·H(v) Equation 2

By summing the drive torque Th outputted from the drive torque calculator 23 and the preset torque Ts being set separately so as to be equivalent to a desired pushing force, the torque control means 24 calculates a torque command value to be used as a torque command for the torque control shaft and performs torque control of the auxiliary shaft motor 10 that is the torque control shaft, according to the torque command value. For example, the torque control is performed so that the torque of the auxiliary shaft motor 10 that is the torque control shaft agrees with the torque command value.

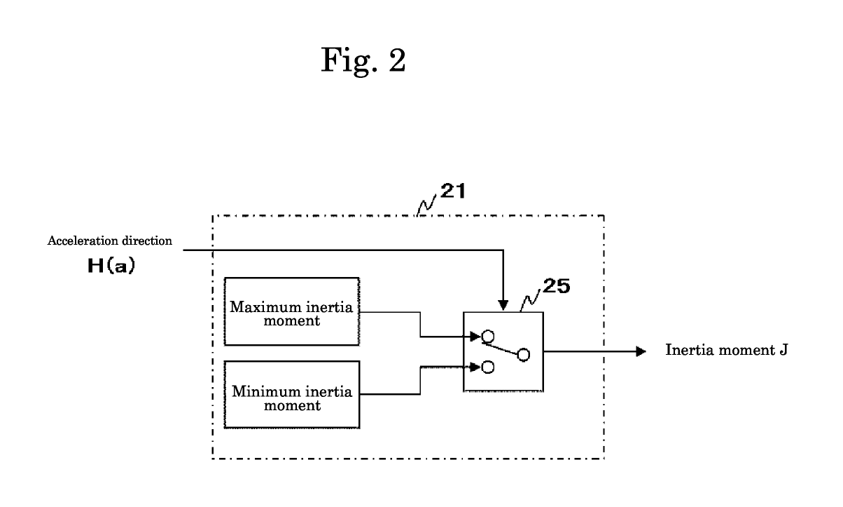

Next, the inertia moment setting means 21 will be explained in detail using FIG. 2. FIG. 2 is a block diagram showing the configuration of the inertia moment setting means 21 in Embodiment 1 of the present invention.

A plurality of inertia moment values is stored in the inertia moment setting means 21 which is provided with an inertia moment selection means 25 that selects and outputs an inertia moment among the plurality of inertia moments according to the inputted acceleration direction information H(a) about the main control shaft. In a case where there are two inertia moment values to be selected, a maximum inertia moment or a minimum inertia moment is selected and outputted. Here, the inertia moment values may be stored in the inertia moment setting means 21, or may be inputted from the controller 12 to the inertia moment setting means 21. The setting of the plurality of the inertia moment values is appropriately changed while taking into account variations expected in the inertia moment of the device.

In the inertia moment setting means 21 shown in FIG. 2, two inertia moment values are stored. The inertia moment selection means 25 selects the maximum value of the inertia moment when the acceleration direction of the main control shaft agrees with the direction of the pushing force in the torque control shaft, and selects the minimum value of the inertia moment when the acceleration direction of the main control shaft differs from the direction of the pushing force in the torque control shaft.

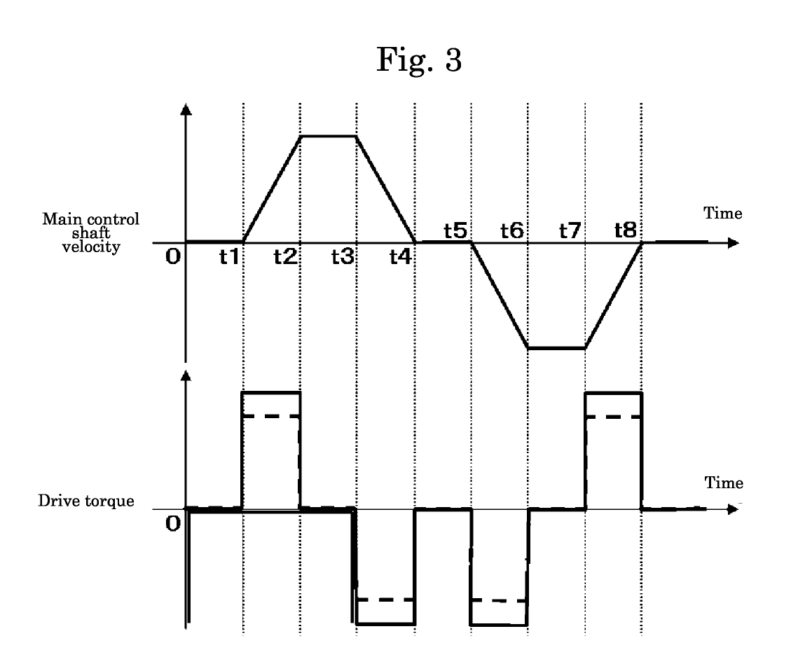

Next, explanation will be made, using FIG. 3, about the behavior of the drive torque due to the inertia moment selected by the inertia moment setting means 21. FIG. 3 shows waveform graphs representing a relation between the main control shaft's driving states and the torque control shaft's drive torque in Embodiment 1 of the present invention.

In FIG. 3, the upper graph represents a relation between the time and the velocity of the main control shaft, and the lower graph represents a relation between the time and the drive torque in the torque control device 11. Here, the drive torque Th in the lower graph of FIG. 3 represents drive torque in a case where the friction coefficient c in Expression 2 is zero. In this case, the drive torque Th is the product of the acceleration a and the inertia moment J (Th=a·J) by Expression 2. In the lower graph of FIG. 3, solid lines indicate cases where the inertia moment selection means 25 in FIG. 2 selects the maximum inertia moment, and broken lines indicate cases where the inertia moment selection means 25 in FIG. 2 selects the minimum inertia moment.

When the main control shaft is driven in the positive and negative directions in an operation pattern in which the velocity changes in a trapezoid-wise manner as shown in the upper graph of FIG. 3, accelerations of ±a are generated during a period between times t1 and t2, a period between times t3 and t4, a period between times t5 and t6, and a period between times t7 and t8.

In these periods, drive torque can be calculated by Equation 2, which is shown in the lower graph. As stated before, the inertia moment selection means 25 in FIG. 2 selects the maximum value of the inertia moment J when the acceleration direction of the main control shaft agrees with the direction of the pushing force in the torque control shaft, and selects the minimum value thereof when the acceleration direction of the main control shaft differs from the direction of the pushing force in the torque control shaft.

In FIG. 3, in a case where the direction of the pushing force for the torque control shaft is defined as the positive direction of the velocity and the drive torque, the maximum value of the inertia moment J is used during the period between the times t1 and t2 and the period between the times t7 and t8, thereby giving the drive torque (solid line portions); and the minimum value of the inertia moment J is used during the period between the times t3 and t4, and the period between the times t5 and t6, thereby giving the drive torque (broken line portions).

By selecting the inertia moment J in this manner to calculate the drive torque, the drive torque can be calculated to always have extra pushing force.

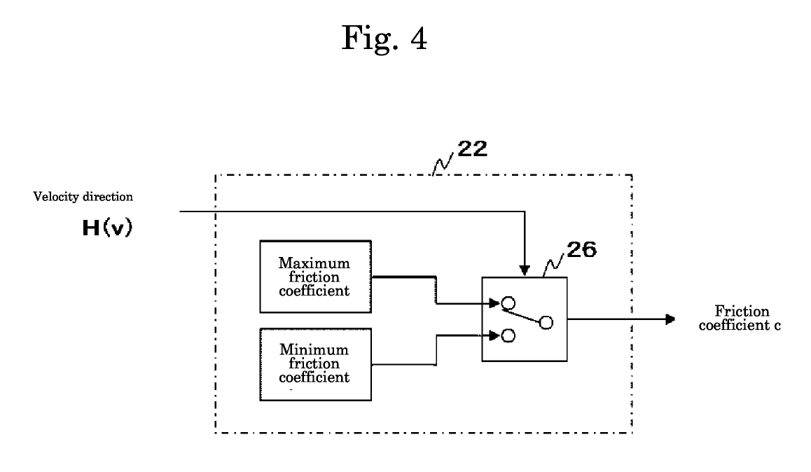

Next, the friction coefficient setting means 22 will be explained in detail, using FIG. 4. FIG. 4 is a block diagram showing the configuration of the friction coefficient setting means 22 in Embodiment 1 of the present invention.

The friction coefficient setting means 22 stores a plurality of friction coefficient values and is provided with a friction coefficient selection means 26 which selects and outputs a friction coefficient value among the plurality of friction coefficient values, according to the inputted velocity direction information H(v) of the main control shaft. In a case of two friction coefficient values from which to be selected, either the maximum friction coefficient value or the minimum friction coefficient value is selected to be outputted. The friction coefficient values may be memorized in the friction coefficient setting means 22, or may be inputted from the controller 12 to the friction coefficient setting means 22. The setting of the plurality of friction coefficient values is appropriately changed while variations expected in the friction coefficient values in the torque control device are taken into account.

In the friction coefficient setting means 22 shown in FIG. 4, two friction coefficient values are stored. The friction coefficient selection means 26 selects the maximum value of the friction coefficient when the velocity direction of the main control shaft agrees with the direction of the pushing force in the torque control shaft, and selects the minimum value of the friction coefficient when the acceleration direction of the main control shaft differs from the direction of the pushing force in the torque control shaft.

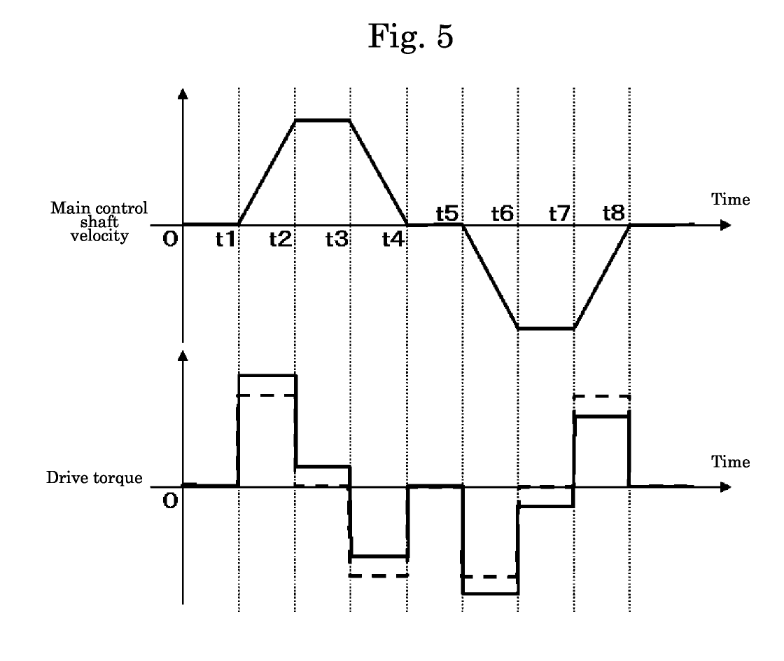

Next, using FIG. 5, explanation will be made about the behavior of the drive torque due to the friction coefficient selected by the friction coefficient setting means 22. FIG. 5 shows waveform graphs indicating a relation between the driving states of the main control shaft and the drive torque of the torque control shaft in Embodiment 1 of the present invention.

Similarly to FIG. 3, FIG. 5 shows that the upper graph represents a relation between the time and the velocity of the main control shaft, and the lower graph represents a relation between the time and the drive torque in the torque control device 11. Here, drive torque Th in the lower graph of FIG. 5 is calculated through Expression 2 in which the inertia moment J is a fixed value. In the lower graph of FIG. 5, solid lines indicate cases where the friction coefficient selection means 26 in FIG. 4 selects the maximum friction coefficient, and broken lines indicate cases where the friction coefficient selection means 26 in FIG. 4 selects zero as the minimum friction coefficient.

When the main control shaft is driven in the positive and negative directions in an operation pattern in which the velocity changes in a trapezoid-wise manner as shown in the upper graph of FIG. 5, velocities of ±v are generated during a period between times t1 and t4, and a period between times t5 and t8.

In those periods, the friction coefficient selection means 26 in FIG. 4 selects the maximum value of the friction coefficient c when the velocity direction of the main control shaft agrees with the direction of the pushing force in the torque control shaft, and selects the minimum value of the friction coefficient when the velocity direction of the main control shaft differs from the direction of the pushing force in the torque control shaft.

In FIG. 5, in a case where the direction of the pushing force is defined as the positive direction of the velocity and the drive torque, the maximum value of the friction coefficient c is used during the period between the times t1 and t4, thereby giving the drive torque (solid line portions); and the minimum value of the friction coefficient c is used during the period between the times t5 and t8, thereby giving the drive torque (broken line portions).

By selecting the friction coefficient c in this manner to calculate the drive torque, the drive torque calculation can always be directed to cause an augmented pushing force.

As explained above, the torque control device in Embodiment 1 of the present invention does not use driving state information on the torque control shaft, but is configured so as to calculate drive torque of the torque control shaft on the basis of driving state information on the main control shaft; therefore, it is unnecessary to separately provide a detection device such as a linear scale device for obtaining the torque control shaft's relative position to the main control shaft, simplifying the configuration of the torque control device.

Furthermore, a method is applied in which the values of the inertia moment and the friction coefficient (especially, their maximum values and minimum values) that are mechanical parameters are selected while the variations of the inertia moment and the friction coefficient are taken into account, on the basis of the main control shaft's driving information. By means of this, the torque control for the torque control shaft can be performed so as to always cause an augmented pushing force, whereby positional deviations of the main control shaft and the torque control shaft can be prevented from being generated even when there exist variations and errors in the mechanical parameters.

### INDUSTRIAL APPLICABILITY

The torque control device according to the present invention is useful as a torque control device which drives, while giving a constant force from a torque control shaft to a workpiece driven by a main control shaft, the torque control shaft in synchronism with the main control shaft; and, in particular, the torque control device is suitable for a torque control device for a motor driving an industrial mechanical device.

1. A torque control device in which while a driver driven by a torque control shaft applies a pushing force to a workpiece driven by a main control shaft, the torque control shaft is driven in synchronism with the main control shaft, comprising:
a mechanical parameter setting means that sets a mechanical parameter representing a mechanical property of the driver on the basis of a driving state of the main control shaft so as to cause the pushing force to be augmented;
a follow-up drive torque calculator that calculates follow-up drive torque necessary for the torque control shaft to follow up the driven main control shaft, on the basis of the mechanical parameter set by the mechanical parameter setting means and the driving state of the main control shaft; and
a torque control means that calculates a torque command value by adding the follow-up drive torque and preset torque being set separately, and controls the torque control shaft so that the torque control shaft's torque agrees with the torque command value.

2. The torque control device according to claim 1, wherein the mechanical parameter setting means stores a plurality of mechanical parameter values representing the mechanical property of the driver, and selects and sets according to the driving state of the main control shaft, either a maximum value or a minimum value from the stored mechanical parameters.

3. The torque control device according to claim 2, wherein the mechanical parameter setting means includes an inertia moment setting means for handling the torque control shaft's inertia moment as the mechanical parameter,
wherein on the basis of acceleration of the main control shaft, the inertia moment setting means sets a maximum value of the inertia moment when the direction of the acceleration agrees with that of the pushing force, and sets a minimum value of the inertia moment when the direction of the acceleration differs from that of the pushing force,
and wherein the follow-up drive torque includes acceleration/deceleration torque that is a product of an inertia moment set by the inertia moment setting means and the acceleration of the main control shaft.

4. The torque control device according to claim 2, wherein the mechanical parameter setting means includes a friction coefficient setting means for handling a friction coefficient of the torque control shaft's inertia moment as the mechanical parameter,
wherein on the basis of a velocity of the main control shaft, the friction coefficient setting means sets a maximum value of the friction coefficient when the direction of the velocity agrees with that of the pushing force, and sets a minimum value of the friction coefficient when the direction of the velocity differs from that of the pushing force,
and wherein the follow-up drive torque includes friction torque calculated from a friction coefficient set by the friction coefficient setting means and the velocity of the main control shaft.
